(19) United States
(12) Patent Application Publication
(10) Pub. No.: US 2014/0338846 A1
(43) Pub. Date: Nov. 20, 2014

(54) ELECTROSTATICALLY CONTROLLABLE DEVICE

(71) Applicant: KONINKLIJKE PHILIPS N.V., EINDHOVEN (NL)

(72) Inventors: Rifat Ata Mustafa Hikmet, Eindhoven (NL); Ties Van Bommel, Eindhoven (NL); Cornelis Eustatius Timmering, Eindhoven (NL); Wilhelmus Johannes Hendricus Ansems, Eindhoven (NL); Jacobus Johannes Van Glabbeek, Eindhoven (NL)

(21) Appl. No.: 14/370,099

(22) PCT Filed: Dec. 20, 2012
(86) PCT No.: PCT/IB2012/057508

§ 371 Date: Jul. 1, 2014

Related U.S. Application Data
(60) Provisional application No. 61/582,519, filed on Jan. 3, 2012.

(51) Int. Cl. E06B 9/40

(52) U.S. Cl. CPC E06B 9/40; E06B 2009/402
USPC 160/310

(57) ABSTRACT

An electrostatically controllable optical device is provided, comprising:—a transmissive substrate (101);—a transmissive electrode (102) arranged on a surface of said substrate;—a transmissive dielectric layer (103) arranged on said electrode; and—a flexible roll-up blind (104) attached to said dielectric layer, said flexible roll-up blind comprising a flexible electrode (106) and a flexible optically functional layer (105) provided on said flexible electrode, said flexible roll-up blind having naturally a rolled configuration and being capable of unrolling in a roll-out direction in response to an electrostatic force. At least one of said transmissive electrode, said transmissive dielectric layer, said flexible electrode and said flexible optically functional layer is adapted with respect to its shape, size, and/or position relative to another one of said transmissive electrode, said transmissive dielectric layer, said flexible electrode and said flexible optically functional layer, to allow partial unrolling but prevent complete unrolling of said flexible roll-up blind. The electrostatically controllable optical device provides improved switching reliability, and is relatively simple to manufacture.

### FIELD OF THE INVENTION

The present invention relates to the field of electrostatically controllable optical roll-up blinds, and to light control panels using such roll-up blinds.

### BACKGROUND OF THE INVENTION

Daylight entering a house or building is traditionally controlled using window roll-up blinds or shutters that are operated manually or by motors. Where windows must keep a certain degree of transparency, for example in vehicles, permanently shaded (tinted) windowpanes are often used to reduce light and heat transmission.

Energy saving aspects of daylight control for buildings and vehicles is today also becoming increasingly important. For example, in order to reduce the energy spent on climate control, it is desirable to allow control of the amount of sunlight and heat entering a building though the windows. It is also desirable to be able to control the amount of light and/or heat exiting a building.

In recent years, so-called smart windows have been developed, which allow light transmission control using for example electrochromic layers, liquid crystals or suspended particles. Smart windows are capable of switching from a transmissive state to a partially blocking or reflective state. However, smart windows using electrochromic layers have a colored appearance, which may be undesirable for many applications. Furthermore, suspended particle devices suffer from low transparency in the “open” state, due to light absorption by the particles also in the aligned state. As an alternative, electrically controllable micro-blinds have been suggested, which in the rolled-up state may provide a higher degree of transparency compared to other solutions, and which may be precisely controlled in any desirable pattern.

U.S. Pat. No. 4,266,339 discloses an electrostatic device comprising a rollable electrode comprising a glass substrate, a film of transparent electrically conductive tin oxide deposited on the surface of the glass, and a layer of clear polypropylene overlying the conductive tin oxide film. A variable electrode consists of a sheet of polyethylene terephthalate having on one surface a thin aluminum film, the variable electrode forming a tight roll. The outermost end of the electrode is bonded to the insulative polypropylene layer. Upon the application of an electric potential the variable electrode is attracted to the fixed electrode (the tin oxide layer) and rolls out. The electrode is prevented from completely unrolling by a bar stop which serves to maintain the axis of the curled edge. However, a drawback of this solution is that it is difficult, and thus costly, to manufacture.

Thus, there remains a need in the art for improved technical solution for increasing the switching reliability of electrically controlled thin film blinds.

### SUMMARY OF THE INVENTION

It is an object of the present invention to overcome this problem, and to provide an improved electrostatically controllable roll-up device, which provides fast and reliable switching from the unrolled state to the rolled-up state.

According to a first aspect of the invention, this and other objects are achieved by an electrostatically controllable optical device, comprising:
a transmissive substrate;
a transmissive electrode arranged on a surface of said substrate;
a transmissive dielectric layer arranged on said electrode; and
a flexible roll-up blind attached to said dielectric layer, said flexible roll-up blind comprising a flexible electrode and a flexible optically functional layer provided on said flexible electrode, said flexible roll-up blind having naturally a rolled configuration and being capable of unrolling in a roll-out direction in response to an electrostatic force,

wherein at least one of said transmissive electrode, said transmissive dielectric layer, said flexible electrode and said flexible optically functional layer is adapted with respect to its shape, size, and/or position relative to another one of said transmissive electrode, said transmissive dielectric layer, said flexible electrode and said flexible optically functional layer to allow partial unrolling but prevent complete unrolling of said flexible roll-up blind. By preventing complete unrolling of the device, the roll-up blind can be faster and more reliably rolled back to its initial, rolled-up state.

Thus, in embodiments of the invention, upon application of an electric field over the electrodes, the flexible roll-up blind is only partially unrolled, and a distal portion of the flexible roll-up blind maintains a curvature.

The electrostatically controllable optical device may be adapted such that the applied electric field is weaker or absent at a distal portion of the roll-up blind compared to the field strength at a proximal portion of the roll-up blind. Typically, the transmissive electrode may be patterned in relation to the flexible electrode, or the flexible electrode may be patterned in relation to said transmissive electrode. Such devices are relatively easy to manufacture and do not require additional steps for applying structures such as a bar stop. For example, at least one of the transmissive electrode and the flexible electrode may be patterned to form a gap at or near a distal portion of said transmissive electrode or flexible electrode, respectively. By “gap” is meant that there is an area lacking electrode material.

In other embodiments, the flexible conductive layer if completely unrolled would extend beyond an edge or a gap of the transparent electrode in the roll-out direction. However, since there is no electrostatic force acting on the flexible electrode where there is no transparent electrode, the distal end of the roll-up blind will not be unrolled.

In other embodiments, a distal portion of the flexible roll-up blind in the roll-out direction may be less conductive than a major portion of the roll-up blind, or non-conductive.

In other embodiments, the transmissive electrode and the transmissive dielectric layer may be shaped to form a protruding structure which physically and electrostatically prevents the roll-up blind from unrolling completely. For example, a protruding member may be provided between the substrate and the transmissive electrode to force the transmissive electrode to protrude from the substrate.

In other embodiments, a portion of the flexible optically functional layer located at or near a distal end of the flexible roll-up blind may be thicker than the rest of the flexible optically functional layer.

In another aspect, the invention relates to a light control panel, comprising an electrostatically controllable optical device according to claim 1, wherein a plurality of roll-up blinds is arranged on a common substrate, and wherein at least one of said transmissive electrode, said transmissive dielectric layer, said flexible electrode and said flexible optically functional layer is adapted with respect to its shape, size, and/or position relative to another one of said transmissive electrode, said transmissive dielectric layer, said flexible electrode and said flexible optically functional layer, to allow partial unrolling but prevent complete unrolling of at least some of said flexible roll-up blinds.

Optionally, the panel may further comprise at least one optoelectronic device, for example a photovoltaic cell or a light-emitting arrangement, typically a solid state light source such as an LED.

In a further aspect, the invention related to a window comprising a light control panel as described above.

Furthermore, there is provided a method of manufacturing an electrostatically controllable optical device comprising a plurality of flexible roll-up blinds as described above, comprising
arranging a transmissive electrode layer on a transmissive substrate;
arranging a transmissive dielectric layer to cover said transmissive electrode layer;
depositing an adhesive material on portions of said transmissive dielectric layer;
arranging a flexible film on said adhesive material and said dielectric layer, said flexible film comprising a flexible electrode layer and a flexible optically functional layer, and said flexible layer having naturally a rolled-up configuration and being capable of unrolling in response to electrostatic force;
curing said adhesive material; and
cutting the flexible film in areas between said portions comprising adhesive material to produce said plurality of flexible roll-up blinds;

wherein the transmissive electrode layer is patterned with respect to the flexible film, or the flexible electrically conductive layer is patterned with respect to the transmissive electrode layer. For example the transmissive electrode layer may be patterned to form a gap at a distal portion of the layer.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIGS. 1a and 1b schematically show perspective views of an electrostatically controllable optical device according to embodiment of the invention.

FIG. 2-8 show cross-sectional side views of electrostatically controllable optical devices according to various embodiments of the invention.

FIG. 9 is a perspective view of a light control panel according to embodiments of the invention.

As illustrated in the figures, the sizes of layers and portions may be exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

The inventors have found that the problem of unreliable rolling back to the initial, rolled-up state, may be reduced by avoiding complete unrolling of the blind. Advantageously, such complete unrolling may be prevented by suitably adapting the size and/or shape of at least one of the layers of the panel.

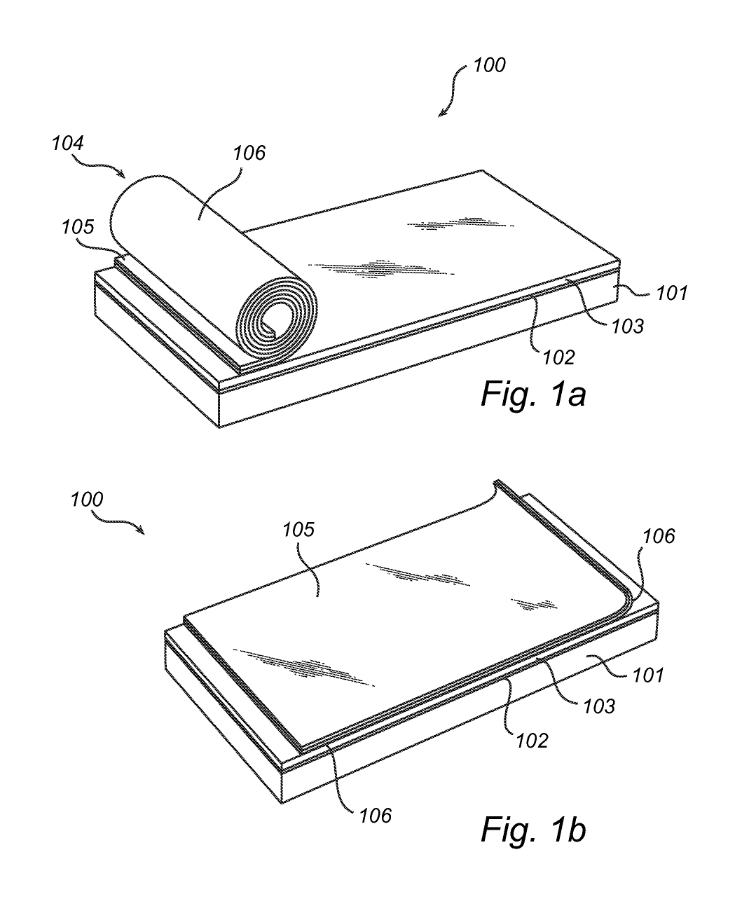

FIG. 1a-b illustrate the general structure of a panel comprising a roll-up blind according to the present invention. The device 100 comprises a transmissive substrate 101, typically a glass plate, on which is arranged a thin film roll-up blind 104. The roll-up blind 104 has a naturally rolled-up configuration and may be reversibly unrolled (FIG. 1b) in response to the application of an electric potential. In the unrolled, planar configuration (FIG. 1b) the roll-up blind 104 covers a larger part of the substrate 101 compared to its rolled-up configuration. When the electric potential is removed, the roll-up blind 104 reassumes its original rolled-up configuration.

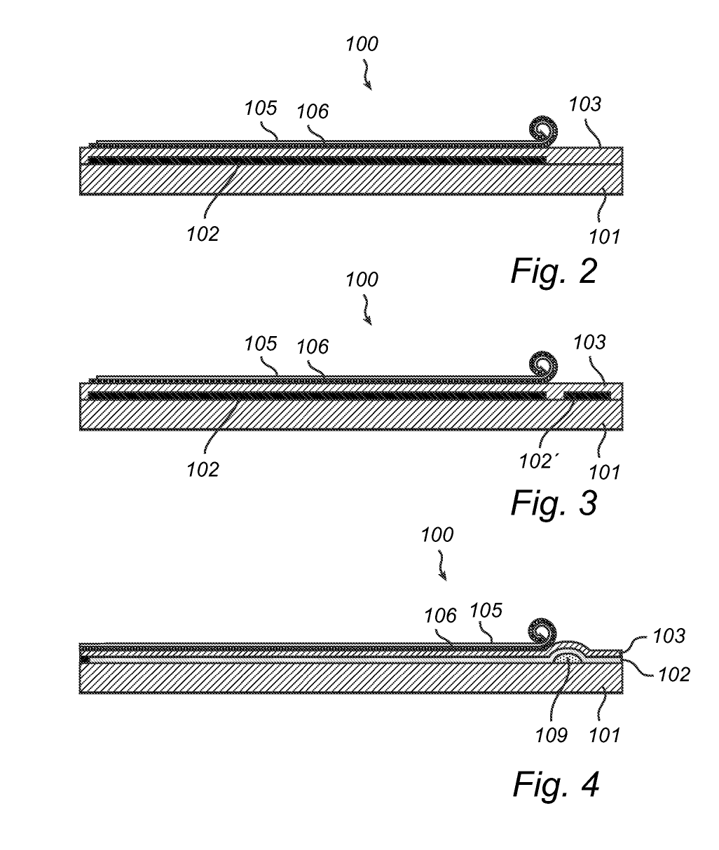

As shown in FIG. 1b, even in the unrolled configuration, the distal end of the blind is not completely unrolled. in fact, the present inventors have found that by preventing the blind from completely unrolling, i.e. by maintaining a certain degree of curvature at the distal end of the blind, the blind will be capable of fast, reliable switching back to the initial rolled-up state. FIGS. 2-8 illustrate various means of achieving this purpose.

As used herein, “transmissive” refers to the capability of transmitting at least some wavelengths of electromagnetic radiation. A transmissive object may be at least partly translucent, or completely transparent. Furthermore, “light transmissive” refers particularly to the capability of transmitting visible electromagnetic radiation and optionally also other wavelengths. A light transmissive object has at least some degree of translucency. “Infrared transmissive” or “IR transmissive” refers to the capability of transmitting electromagnetic radiation of the infra red wavelength range, i.e. heat radiation. An object that is IR transmissive is not necessarily light transmissive, but may be so, and thus may or may not be translucent or transparent.

As used herein, “light” refers to visible light, i.e. electromagnetic radiation in the wavelength range of about 400 nm to about 740 nm. “Infrared” or “IR” refers to electromagnetic radiation of wavelengths longer than about 700 nm, typically longer than 750 nm.

As used herein, “roll-up blind” refers to a flexible layer or film which is reversibly mutatable between a rolled-up configuration, and an at least partially unrolled (typically planar) configuration capable of covering an underlying surface. In the present specification “blind” is not intended to refer to impaired visibility or impaired light transmission in general, although the flexible optically functional layer of the roll-up blind may optionally have light reflective, light absorbing or light guiding properties.

As used herein, “optoelectronic device” refers to semiconductor devices employing quantum mechanical effects of light, using or producing light. Examples of optoelectronic devices include photovoltaic devices (e.g. solar cells and other photodiodes), laser diodes and light emitting diodes (also including organic light emitting diodes).

As used herein, “optical contact” refers to a path of light extending from one object to another object where said objects are in optical contact. “Direct optical contact” is intended to mean that said path of light extends from the first object to the second object without having to pass through an intermediate medium such as air or an optical element.

As used herein, “proximal”, means closer to the point of attachment of the roll-up blind to the underlying substrate, as opposed to “distal” which refer to farther away from the point of attachment of the roll-up blind to the substrate. The end of the roll-up blind that is prevented from unrolling thus represents the distal end of the roll-up blind.

As used herein, the transmissive electrode being patterned in relation to the flexible electrode layer (or vice versa) means that a portion, in particular a distal portion, of the transmissive electrode layer is discontinuous and has a pattern that is different from a layer shape or pattern of the flexible electrode (assuming completely unrolled state), such that at a certain area of the flexible electrode, typically of a distal portion thereof, if completely unrolled, would be aligned with an area lacking the transmissive electrode material.

As illustrated in the figures, the sizes of layers, regions and domains etc. may be exaggerated for illustrative purposes and, thus, are provided to illustrate the general structures of embodiments of the present invention.

The structure and function of the roll-up blind will now be described in more detail with reference to FIG. 1. The device 100 comprises a planar substrate 101 on which is arranged a first transmissive electrode layer 102 connected to a voltage source (not shown). An insulating dielectric layer 103, which may be transmissive, is arranged over the electrode 102 to cover the electrode 102 and to spatially separate it from the roll-blind 104. The roll-blind 104 comprises a flexible optically functional layer 105, typically formed of a self-supporting film. On the side of the roll-up blind 104 intended to face the dielectric layer 103, the optically functional layer 105 is coated with a second electrode layer 106, which may also be connected to the voltage source.

The roll-up blind 104 assumes its natural rolled-up configuration due to elastic forces resulting e.g. from inherent stress. The stress could result from different thermal expansions coefficients of the materials of the optically functional layer 105 and the electrode layer 106, respectively, or could be induced by the fabrication (e.g. layer deposition) method, for example as described in U.S. Pat. No. 7,684,105.

Upon application of an electric field between the first electrode 102 and the second electrode 106, the roll-up blind 104 unrolls due to electrostatic force and thus assumes a stretched, planar position over the dielectric layer 103, as illustrated in FIG. 1b. When the electric field is removed (voltage is switched off), the electrostatic force is eliminated and the roll-up blind 104 reverts to its curled position (FIG. 1a) due to inherent stress as described above. Due to the fact that the blind is not completely unrolled, but has some curvature at its distal portion, the operation of rolling back to the initial, rolled-up state is quicker and more reliable.

For example, in one embodiment, the optically functional layer 105 is a film of poly(ethylene terephthalate) (PET), and the second electrode layer 106 is an aluminum layer, which is also thin enough to be flexible. The different thermal expansion coefficient of these materials may contribute to the elastic force that causes the roll-up blind 104 to curl. The roll-up blind maintains a rolled-up (curled) position also when the device 100 is vertically oriented.

It may be assumed that three (or four) forces determine the behavior of the roll-up blind 104, which forces are the elastic force, and the electrostatic force, but also van der Waals force and to a minor extend the gravitational force. The elastic force may be a result of e.g. shrinkage during manufacturing. The elastic force acts on second electrode 106 even when there is no electric field present. By applying a voltage between or across first electrode 102 and the second electrode 106, an electrostatic force directed to unroll the roll-up blind 104 comprising the second electrode 106 and keep it in the unrolled state, is obtained. The electrostatic force is the attractive force between first and second electrodes 102 and 106 obtained by applying said voltage. The van der Waals force is the force between the dielectric material 103 and the roll-up blind 104. This force depends on the distance between the two media, the roughness of the media and the material properties; the smaller the distance, the larger the van der Waals force. Finally, the gravitational force acts upon the roll-up blind 104 which also depends on its orientation. In general, roll-up blind 204 may be very thin and therefore have a very low mass, and accordingly the gravitational force may be negligible.

To unroll (activate) the roll-up blind 104 and to maintain it in its unrolled state, the elastic force, which always acts on the roll-up blind 104 and is directed at rolling or curling it, must be overcome. For this purpose, a sufficient electrostatic force must be generated, and may be obtained by applying an adequate voltage between the transmissive first electrode layer 102 and the second electrode layer 106. To return the unrolled roll-up blind 104 to its rolled (deactivated) state (FIG. 1a), the voltage is eliminated so that the electrostatic force no longer acts on the roll-up blind 104. The elastic force then causes the roll-up blind 104 to reassume it rolled-up state, under condition that the elastic force it greater than the van de Waals force.

FIGS. 2 and 3 illustrate embodiments of the invention in which the first electrode layer 102 is adapted to prevent complete unrolling of the roll-up blind 104. In the embodiment of FIG. 2, the electrode layer 102 is shorter than the roll-up blind 104, i.e. the distal portion of the roll-up blind, if completely unrolled would extend beyond the electrode layer 102. However, due to the absence of an electric field in the distal portion of the device 100, the roll-up blind is not unrolled beyond the extension of the electrode layer 102.

The embodiment of FIG. 3 utilizes the same principle, but instead of being shorter, the electrode layer 102 is patterned to provide a gap at or near the distal portion of the device 100. The gap results in a locally weakened or absent electric field, such that the blind is not unrolled to bridge the gap. The patterned area lacking electrode material may have any suitable shape, for example a line or a grid pattern. The portions of electrode layer 102, 102′ may be connected.

It is envisaged that the electrode layer 102 may be a continuous layer, or a discontinuous, patterned layer over the whole area of shown in FIG. 1. In cases where the electrode layer is patterned, e.g. to form a grid structure, the dimension of the gaps of the pattern may be increased to serve the same function as the electrode layer 102 illustrated in FIG. 3.

In other embodiments the first electrode layer 102 and the dielectric layer 103 may be shaped to prevent complete unrolling of the blind 104. For example, a distal portion of the electrode layer 102 and/or the dielectric layer 103 may be shaped to form a protruding structure to keep the distal portion of the roll-up blind in a curled shape by both mechanical and electrostatic action. Such an effect may be obtained by the embodiment shown in FIG. 4, in which a protruding member 109 is provided on the substrate 101 and covered by the electrode layer 102 and the dielectric layer 103, such that the electrode layer and the dielectric layer also protrudes from the otherwise planar surface formed by the electrode layer and the dielectric layer. The protruding member may optionally be formed of the same material as the substrate, but may alternatively also be formed on another material. The protruding member 109 may be made of a polymer material, for instance a photoresist material.

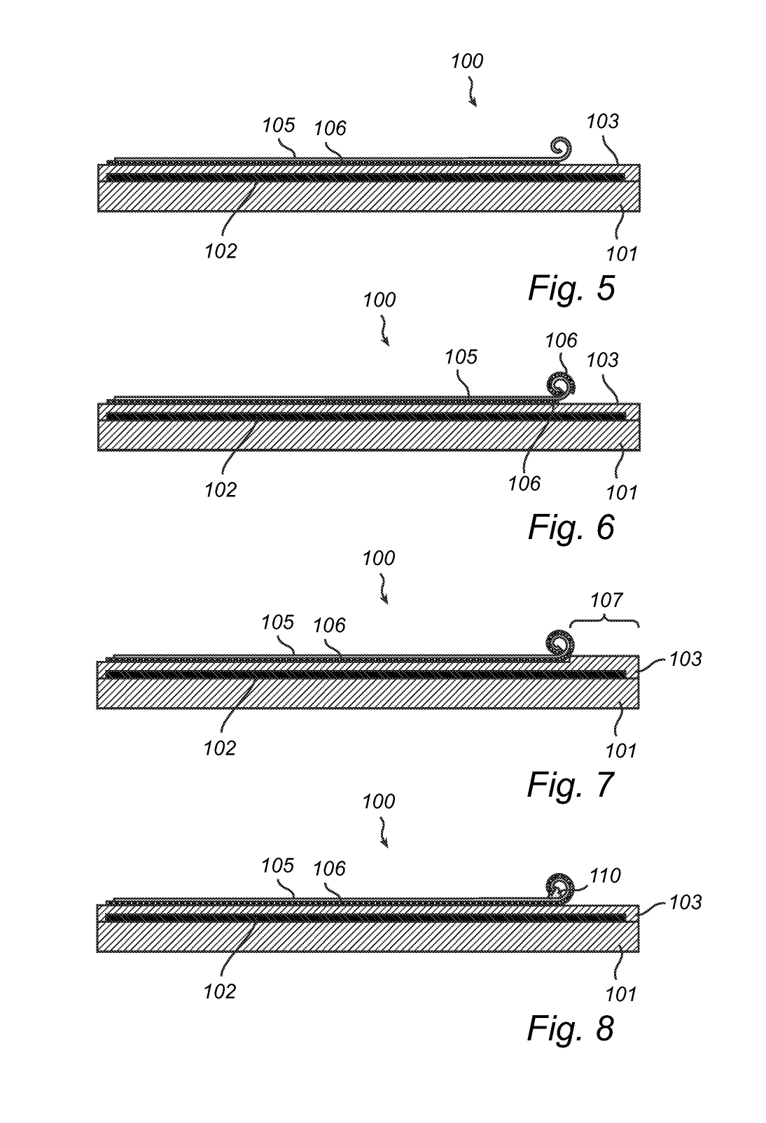

FIGS. 5 and 6 illustrate embodiments of the invention where the flexible electrode layer 106 is adapted to prevent complete unrolling of the roll-up blind 104. In FIG. 5, the flexible electrode layer 106 is shorter than the optically functional layer 105 and optionally also shorter than the first electrode layer 102. That is, the distal portion of the optically functional layer 105 extends beyond the distal portion of the flexible electrode layer 106. The distal portion of the optically functional layer 105 extending beyond the flexible electrode layer 106 may be very small. Thus, the distal portion of the roll-up blind may still curl.

In the embodiment of FIG. 6, the flexible electrode 106 is patterned to form a gap near the distal end of the roll-up blind, such that the unrolling operation is arrested at said gap due to a weaker electric field.

FIG. 7 illustrates another embodiment of the present invention in which the dielectric layer 103 is made thicker in the region 107 corresponding to the distal portion of the roll-up blind, such that distance between the transmissive electrode 102 and the flexible electrode 106, thus weakening the electric field such that the electrostatic force does not exceed the elastic force responsible for curling of the roll-up blind.

FIG. 8 shows yet another embodiment of the invention in which the distal portion of the optically functional layer and the flexible electrode layer has a permanently curled shape due to bonding of the distal end 111 of the roll-up blind to the optically functional layer 105 via an adhesive bond 110, e.g. glue. The permanently curled shaped may be obtained by applying an uncured adhesive before the blind is allowed to curl (see below).

As described above, the substrate 101 is typically a glass pane. However it could also be made of a plastic. The substrate may have any suitable dimensions and properties useful for the intended application of the panel. The substrate may also have optical properties, e.g. with respect to IR transmission or transparency in general, that are suitable for the intended application.

The first electrode layer 102 is an electrically conductive layer applied on the substrate 101. Preferably, the first electrode layer is transparent, or may have at least the same degree of transparency to visible light as the substrate 101. For example, the first electrode layer 102 may be made of metallic material, such as indium tin oxide (ITO) and aluminium zinc oxide, or of conductive polymers such as polyaniline and poly(3,4-ethylene dioxythiophene) poly(styrene sulfonate) (PEDOT:PSS). Optionally the first electrode layer 202 could be a patterned electrode layer.

The dielectric layer 103 electrically insulates the first electrode layer 102 from the second electrode (flexible conductive layer) 106 of the roll-up blind 104. The dielectric layer may be formed of any suitable material, for example silicon nitride or silicon oxide, or a polymeric material, such as polyimide, benzocyclobutene (BCB) and SU-8. The dielectric layer may have any suitable optical properties, and typically has at least the same degree of transparency to visible light as the substrate and the first electrode layer. Preferably the dielectric layer is transparent. The dielectric layer may have a thickness in the range of from 100 nm to 10 μm, for example in the range of from 300 nm to 1 μm.

The roll-up blind 104 is typically adhered to the dielectric layer via adhesive portions of an adhesive material, such as cured glue. The optically functional layer 105 of the roll-up blind 104 may be formed of a self-supporting, flexible film, typically a polymer film. Examples of polymers suitable for use as the flexible optically functional layer include poly(methyl methacrylate) (PMMA), poly(ethylene terephthalate) (PET), poly(ethylene naphthalate) (PEN) and combinations thereof. The optically functional layer may have a thickness in the range of from about 0.1 to 10 μm.

In embodiments of the invention, the optically functional layer may have a refractive index in the range of from 1.3 to 1.9, depending on the material used.

Furthermore, the optical properties of the flexible optically functional layer may be tuned e.g. by incorporation of particulate material or by the use of additional layers, e.g. a reflective layer, or a layer with a different refractive index. For example, one or more metallic layers of e.g. aluminum or silver may be used to provide reflective properties.

In embodiments of the invention, the optically functional layer may comprise scattering particles, e.g. particles of aluminum oxide (Al₂O₃) or titanium oxide (TiO₂). Suitable particle size may be from 0.1 to 5 μm. To provide partial, diffuse reflection of incident light the optically functional layer may have a content of scattering particles in the range of from 0.1 to 10% by weight of the layer. For concentration higher than 10% by weight, substantially full diffuse reflection of light may be achieved. However, since concentrations above 10% may influence the flexibility of the functional layer, in some embodiments it might advantageous to have an optically functional layer which comprises a stack of at least two thin layers arranged in direct optical contact, wherein a first layer comprises a high concentration of scattering particles and a second layer lacks scattering particles.

Alternatively, in embodiments of the invention, the optically functional layer may comprise light absorbing pigment such as light absorbing particles dispersed in the optically functional layer or light absorbing molecules molecularly dissolved in the optically functional layer. To provide specularly reflective properties, the optically functional layer may comprise a thin reflective metal layer, such as aluminum. For full specular reflection, an aluminum layer having a thickness of 60 nm or more may be used. Furthermore, the optically functional layer may comprise light filters for providing wavelength dependent reflection.

In some embodiments the optically functional layer may comprise a wavelength converting material that converts part of the incident light to light of a different, usually longer, wavelength. Incorporation of a wavelength converting material into the optically functional layer may be advantageous both when the panel comprises light emitting element and when it comprises photovoltaic devices, as explained above. Examples of wavelength converting materials that can be used in the optically functional layer include conventional organic and inorganic wavelength converting materials, such as inorganic phosphors, quantum dots (QDs) and organic luminescent materials such as perylene-based materials, e.g. Lumogen® Red F 300 or F Red 305 (commercially available from BASF).

The optically functional layer may optionally be patterned with light absorbing and/or diffusing and/or specularly reflective material in order to produce visual effects, such as graphics, text or images when the roll-up blinds are in an unrolled (planar) position.

The flexible electrode layer 106 may be a metallic layer, e.g. indium tin oxide (ITO), aluminium or silver. The thickness of the layer 106 may be in the range of 10 nm to 1 μm, and provides flexibility to the layer. When the roll-up blind 104 is intended to be reflective, it may be advantageous to use an aluminum layer as the second flexible electrode layer, since this would reduce the need for additional reflective layers.

The roll-up blind 104 may be a flexible sheet having dimensions in the centimeter range, for example a width in the range of from 0.5 to 20 cm and a length (unrolled) in the range of 0.5 to 20 cm.

In the rolled state, an individual roll-up blind 104 may be rolled at least one complete turn, and typically several turns. The roll-up blind may have a radius of curvature in the range of from 1 to 10 mm. Typically the radius of curvature is uniform over the entire width of the roll-up blind.

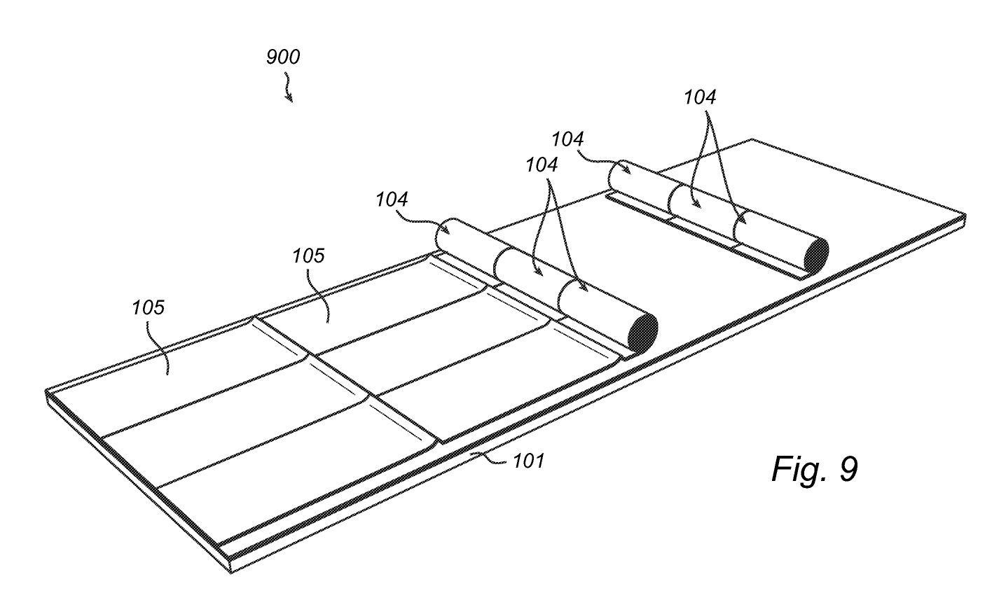

The roll-up blinds described herein may be used in a light control panel for absorbing, reflecting or otherwise controlling incident light, or for emitting light, or for generating electrical energy from light. An example of such a light control panel is schematically illustrated in FIG. 9. The panel 900 comprises a substrate 101 and a plurality, typically one or more arrays as shown in FIG. 9, of said roll-up blinds 104. In some embodiments, the first electrode layer (first electrically conductive layer) may have an in-plane extension so as to cover a substrate surface intended to be covered by a plurality of roll-up blinds, such that a single continuous or discontinuous (patterned) first electrode layer may be used to apply an electric potential over the flexible electrode layers of several roll-blinds. Alternatively, there may be an individual first electrode layer for each roll-blind 104.

In embodiments of the invention, the optically functional layer 105 may have any desired optical characteristics, e.g. being reflective, scattering, absorbing, or transmissive. Similarly, the flexible electrode layer may be e.g. reflective. By suitably adapting the properties of the optically functional layer 105, and optionally also of the flexible electrode layer, the light control panel of FIG. 9 may be designed to absorb, reflect or convert incident radiation. In such embodiments, when the roll-up blinds are in a rolled-up position the panel may transmit electromagnetic radiation as allowed by the characteristics of the substrate 101 which in the case of a conventional window pane may transmit both visible and IR radiation.

In some embodiments, the light control panel may comprise one or more optoelectronic devices, Typically, the optoelectronic element may be arranged in optical contact with said substrate 101 and/or said optically functional layer 105. In such embodiments of the invention, either the substrate 101 or the optically functional layer 105 may function as a waveguide, guiding light to or from the optoelectronic element. The optoelectronic devices may for example comprise solid-state light sources such as LEDs, serving to emit light via the roll-up blinds 104. Alternatively or additionally, the optoelectronic devices may comprise photovoltaic cells, adapted to receive incident light via the roll-up blinds 104 and convert the light into electrical energy.

In embodiments using a light source as the optoelectronic device, a solid state light source such as an LED may be arranged in optical contact with the substrate and/or the optically functional layer of the roll-up blind, to emit light into the substrate and/or the roll-up blind, respectively. When arranged in optical contact with the substrate, light emitted by the light source may be waveguided inside the substrate, the electrode layer and the dielectric layer. Typically the roll-up blind may comprise light extraction structures for extracting the light when the roll-up blind is in an unrolled state.

In some embodiments the optoelectronic device may be a photovoltaic cell (solar cell). Typically, the panel comprises a plurality of photovoltaic cells. Such panels may be useful e.g. in window applications, shielding the interior of a building from strong sunlight while at the same time utilizing the solar energy for generating electricity. In such embodiments, at least one photovoltaic cell is arranged in optical contact with the optically functional layer of a roll-up blind. For example the photovoltaic cell may be arranged on a portion of the blind, in contact with the optically functional layer. The portion where the photovoltaic cell is arranged may be an anchoring portion, where the roll-up blind on the side thereof opposite to the photovoltaic cell is adhered, typically using optical glue, to the dielectric layer of the substrate. In an alternative embodiment a photovoltaic device is arranged in contact with a lateral surface of the optically functional layer of the roll-up blind and receives light guided by the roll-up blind. Thus, in embodiments employing a photovoltaic cell, the optically functional layer may operate as a waveguide, receiving incident light and guiding it to the photoactive layer of the photovoltaic device which converts light into electrical energy.

The photovoltaic cell may be any conventional photovoltaic cell that can be made small enough to fit on or next to the roll-up blinds. Suitably an individual photovoltaic cell may have a length of from 0.5 to 20 cm, and a width of from 0.5 to 20 cm. The thickness of the photovoltaic cell may be in the range of from 20 μm to e.g. 3 mm. For example, flexible CIGS solar cells, which may be advantageous in the present invention, may have a thickness of about 30 μm. The photovoltaic cell may be controllable independently of the roll-up blind.

For example, in some embodiments in which the panel is used for window applications, the panel may function as an ordinary window glass panel during the day, the roll-up blinds 103 being rolled up, transmitting light and optionally IR radiation to the interior of a room, a building or a vehicle. When daylight is poor or absent, LEDs 104 may be turned on to provide additional lighting. Optionally, some or all of the roll-up blinds 103 may then be unrolled to prevent light leakage to the exterior. Thus, the panel may function as a light-emitting window towards the interior of a room or a building, while allowing little or no light to escape to the exterior. Hence, it may be a very energy efficient light source. Such embodiments could also be combined with photovoltaic cells as described above.

The electrostatically controllable optical device according to the invention may be produced as follows. An electrically conductive layer 102 as described above is deposited onto a substrate 101 by conventional techniques, e.g. chemical vapor deposition (CVD), physical vapor deposition (PVD), or other conventional coating or printing techniques. The electrically conductive layer 102 may be a patterned layer, e.g. forming a grid pattern, produced by printing or by lithography. The dimensions of the pattern may be adapted to produce embodiments according to FIGS. 2 and 3.

In the embodiment according to FIG. 5, a protruding element is applied to the substrate surface before deposition of the electrode 102.

Next, a dielectric layer 103 as described above is applied over the dielectric layer by any suitable technique, e.g. using chemical vapor deposition (CVD) or physical vapor deposition (PVD) for silicon nitride, or spin coating for a polymeric layer. Adhesive material, typically glue, is applied to portions (typically as thin lines) distributed over the surface of the dielectric material, intended to form anchoring regions for the individual roll-up blinds. Onto the dielectric layer and the adhesive portions is applied a continuous film 105 of flexible polymeric material as described above, e.g. PET, which has previously been coated with a thin electrically conductive layer 106 on the side of the film intended to face the dielectric layer. The dimensions of the polymeric material (forming the optically functional layer) and of the thin electrically conductive layer (forming the flexible electrode layer 106) may be adapted to produce the embodiments of FIGS. 6 and 7.

After application of the roll-up blind to the adhesive portions, the adhesive may be cured. When the roll-up has adhered via the adhesive portions, the continuous film comprising the optically functional layer 105 and the coating of electrically conductive layer 106 is separated e.g. by laser cutting, between the adhesive portions to form a plurality of individual roll-up blinds 104, each adhering via an adhesive portion to the dielectric layer near one of its edges. Once separated (cut) so as to be attached to the dielectric layer only at one end, the free end of each individual roll-up blind curls due to inherent stress as explained above.

The protruding member of the embodiment of FIG. 4 may be produced e.g. by applying a monomeric material comprising an initiator, e.g. by printing, on the substrate 101 and subsequently cure the material to form a solid protrusion of polymeric material. Alternatively, a liquid solution of polymer material may be deposited, e.g. by printing, on the substrate , and the solvent may subsequently be removed by evaporation to solidify the protrusion. Next, the electrode layer 103 and the dielectric layer may be deposited as described above.

The embodiment of FIG. 8 may be produced by applying an uncured adhesive material 109 to the distal portion of the blind before the individual blinds are formed by cutting. After cutting the individual roll-up blinds as described above, the roll-up blinds curl (as explained above) and the adhesive may subsequently be cured to fix the distal end of the blind in a curled shape.

The optoelectronic devices, e.g. LEDs or photovoltaic devices may be produced and applied to the panel using conventional methods known in the art.

The panel according to the invention may be applied as a window pane to form a window of a building, or of a vehicle for example in automotive, marine or aerospace applications. For example, the panel may form one of the permanent panes of a double-glaze window. Alternatively, the panel may be a pane that is permanently or detachably placed between the two panes of a double-glazed window, or in front of a single-glazed or double-glazed window. In some embodiments the panel may be used as a sun roof of a car. In other embodiments, the panel may be used as an architectural feature, an interior light-emitting window or a privacy window for professional or home settings.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An electrostatically controllable optical device, comprising:
a transmissive substrate;
a transmissive electrode arranged on a surface of said substrate;
a transmissive dielectric layer arranged on said electrode; and
a flexible roll-up blind attached to said dielectric layer, said flexible roll-up blind comprising a flexible electrode and a flexible optically functional layer provided on said flexible electrode, said flexible roll-up blind having naturally a rolled configuration and being capable of unrolling in a roll-out direction in response to an electrostatic force,
wherein at least one of said transmissive electrode, said transmissive dielectric layer, said flexible electrode and said flexible optically functional layer is adapted with respect to its shape, size, and/or position relative to another one of said transmissive electrode, said transmissive dielectric layer, said flexible electrode and said flexible optically functional layer to allow partial unrolling but prevent complete unrolling of said flexible roll-up blind.

2. The electrostatically controllable optical device according to claim 1, wherein, upon application of an electric field over the electrodes, the flexible roll-up blind is partially unrolled and a distal portion of the flexible roll-up blind maintains a curvature.

3. The electrostatically controllable optical device according to claim 1, which is adapted such that said electric field is weaker or absent at a distal portion of the roll-up blind compared to the field strength at a proximal portion of the roll-up blind.

4. The electrostatically controllable optical device according to claim 1, wherein said transmissive electrode is patterned in relation to said flexible electrode, or said flexible electrode is patterned in relation to said transmissive electrode.

5. The electrostatically controllable optical device according to claim 4, wherein at least one of the transmissive electrode and the flexible electrode is patterned to provide a gap at or near a distal portion of said transmissive electrode or flexible electrode, respectively.

6. The electrostatically controllable optical device according to claim 1, wherein the flexible conductive layer if completely unrolled extends beyond an edge or a gap of the transparent electrode in the roll-out direction.

7. The electrostatically controllable optical device according to claim 1 wherein a distal portion of the flexible roll-up blind in the roll-out direction is less conductive than a major portion of the roll-up blind, or non-conductive.

8. The electrostatically controllable optical device according to claim 1 wherein the transmissive electrode and the transmissive dielectric layer are shaped to form a protruding structure.

9. The electrostatically controllable optical device according to claim 7, wherein a protruding member is provided between the substrate and the transmissive electrode to force the transmissive electrode to protrude from the substrate.

10. The electrostatically controllable optical device according to claim 1, wherein a portion of the flexible optically functional layer located at or near a distal end of the flexible roll-up blind is thicker than the rest of the flexible optically functional layer.

11. A light control panel, comprising an electrostatically controllable optical device according to claim 1, wherein a plurality of roll-up blinds is arranged on a common substrate, and wherein at least one of said transmissive electrode, said transmissive dielectric layer, said flexible electrode and said flexible optically functional layer is adapted with respect to its shape, size, and/or position relative to another one of said transmissive electrode said transmissive dielectric layer, said flexible electrode and said flexible optically functional layer, to allow partial unrolling but prevent complete unrolling of at least some of said flexible roll-up blinds.

12. A light control panel according to claim 11, further comprising an optoelectronic device.

13. A light control panel according to claim 11, wherein the optoelectronic device comprises a photovoltaic cell.

14. A light control panel according to claim 12, wherein said optoelectronic device comprises a light-emitting arrangement.

15. A window comprising a light control panel according to claim 1.
